(19) United States
(12) Patent Application Publication
(10) Pub. No.: US 2026/0251416 A1
(43) Pub. Date: Aug. 27, 2026

(54) SLINGSHOT

(71) Applicant: Deaglan Quinn, Torrington, CT (US)

(72) Inventor: Deaglan Quinn, Torrington, CT (US)

(21) Appl. No.: 19/063,192

(22) Filed: Feb. 25, 2025

(51) Int. Cl. F41B 3/02; A01K 89/08; F41C 27/22

(52) U.S. Cl. CPC F41B 3/02; A01K 89/08; F41C 27/22

(57) ABSTRACT

A slingshot body with a base and two parallel forks extending parallel from each other to define a gap between. The base has a finger hole closer to one of the two forks than to the other and has a concave curvature facing outward that is closer to the other of the forks than to the one of the forks. The base also has opposite sides each with a respective concave curvature that faces away from each other. Each of the two parallel portions has a respective slot. Each of the two forks has a respective central slot and peripheral mounting rail compatible with existing standards which extends from respective fork's outward periphery. The slingshot body can be retained to other bodies (e.g., firearms) using coupling clamps conforming to same rail standard.

### CROSS-REFERENCE TO RELATED APPLICATIONS

Not applicable.

### STATEMENT REGARDING FEDERALLY SPONSORED RESEARCH OR DEVELOPMENT

Not applicable.

THE NAMES OF THE PARTIES TO A JOINT RESEARCH AGREEMENT

Not applicable.

REFERENCE TO A “SEQUENCE LISTING”, A TABLE, OR A COMPUTER PROGRAM LISTING APPENDIX SUBMITTED ON A COMPACT DISC AND AN INCORPORATION-BY-REFERENCE

Not applicable.

### STATEMENT REGARDING PRIOR DISCLOSURES BY THE INVENTOR

Not applicable.

### BACKGROUND OF THE INVENTION

### Field of the Invention

The invention relates to a compact multi-function ergonomic slingshot grip having integrated rails that allow for compatibility with an array of elastic bands and tubings using accessory clamps. The Picatinny conforming rails also allow the grip to function as a removable, accessorial grip for cameras, guns, glass breaker/striking device, bicycle grip, etc.

### Discussion of Related Art

In February 2023 while waiting for work to start up again in my industry, I was looking for something inexpensive and fun to occupy my free time. Slingshots struck my fancy being relatively economical; however, after doing an extensive search online of what was available and purchasing a few, I found myself dissatisfied. The primary grievances were with the ergonomics and band attachment methods. My research also revealed “handleless” slingshot designs such as those depicted in US20160305733A1 and U.S. Pat. No. 10,816,302.

US20160305733A1 discloses a handleless slingshot with a folding storage compartment and that does not require that the user grip a handle to shoot it and the folding storage compartment may be removed or omitted if desired. The slingshot includes a storage compartment that can store projectiles (such as steel shot) and/or other supplies. The storage compartment is foldable such that it can be folded into the body of the slingshot to create a compact, portable unit. The slingshot includes a quick-release interchangeable band system that uses clips that matingly engage grooves formed at the ends of the slingshot arms to secure the band. The slingshot includes a guard area which protects the web area of the hand when shooting the slingshot. The slingshot moves the thumb and index finger contact points forward of the band to increase stability and eliminate the need to grip a handle when shooting the slingshot.

U.S. Pat. No. 10,816,302 discloses a slingshot that includes a handle having a plurality of positioning grooves, the grooves spaced along a length of the handle, a pair of arms extending upwardly and forwardly from the handle, each arm having a band attachment device, a pair of wings extending laterally outward and forward from handle, each wing configured to be supported by a portion of a user's hand, an arm brace secured to the handle and a palm plate removably secured to the handle. The palm plate is configured to be removed from one positioning groove of the plurality of positioning grooves and secured to another groove of the plurality of positioning grooves. A handleless slingshot is also provided having a wire or wire-like body including, in one embodiment, a lower portion, a pair of wings connected to one another by the lower portion, a pair of arms, and an upper portion.

What I found unappealing about the ergonomics of existing slingshots on the market was that they were either too small and uncomfortable to shoot for long (they dug into my hand or were difficult to hold) as well as not fitting in a pocket comfortably (due to the Y shape and slight variations thereof) or they were too big and bulky and therefore less portable.

Having free time and enjoying tinkering, I decided to make my own slingshot and crafted the very first grip body out of plywood. I thought it felt good in the hand but needed some way to attach the bands. The next step was making several two piece designs out of plastic cutting boards whereby the elastic bands were sandwiched between the halved body, the body being held together by 1″ spring clamps.

The cutting board sandwich model with the 1″ spring clamps shot really well.

However, despite making elastic replacement pretty easy, the bulky and ugly spring clamps holding the body together were undesirable. I began contemplating the methods I could use to attach elastics securely and in a low-profile manner while also not being onerous to swap out. Until October of 2024 when I purchased a 3D printer, I had been stymied in any progress due to lack of prototype manufacturing equipment.

At one point in my research, I came across the “Indian sling” and thought I might be able to integrate shooting perpendicularly from the originally intended plane of my design. The last model I made prior to the 3D printer, was with the pistol grip/“Indian slingshot” mode in mind (hereafter referred to as “pistol grip” or “pistol grip mode”). I spent an inordinate amount of time shaping fiberglass and epoxy (70+ layers of fiberglass, multiple gluing and hand shaping sessions) however, this model felt really comfortable in the hand for both planes of shooting and I believed I was on to something. I lacked the ability to test fire the pistol grip concept due to not wanting to mess up all the hard work (by experimenting with ways of affixing elastics), so it all remained theoretical.

Fall of 2024, I had time and a little money to invest in a 3D printer. After printing a few models (pursuant to geometry of the cutting board prototype) with basic tension slots in the forks and a simple pistol grip tubing attachment test, I happened to look at my airsoft gun that was lying around and wondered if I could use the slingshot as a fore grip which is where the rest of the design evolved from.

A difficulty in creating this design was, as all the potential features were discovered, how to accommodate as many features as possible without having the same drawbacks as in conventional “multi-function” devices where too many features combined generally reduces the overall utility of each individual feature. I went through over 17 elastic clamp designs to mate with the rails incorporated on the exterior of the forks and at one point tried a two-piece hinged body meant to dispense with clamps by capturing the band in-between the sections. However, it didn't work due to not having enough material for hinge pins without canceling out other functionality.

The ammo storage capability, brass-knuckles like ergonomics and several other features were discovered along the way while working on other portions of the design. The Picatinny rail, often referred to as a “MIL-STD-1913 rail” or simply “1913 rail,” is a bracket used on firearms for mounting accessories, such as scopes, grips, bipods, and lights. It's a versatile conventional system that's been in use for decades and has become a standard accessory mounting platform. The Picatinny rail is a flat row of rectangular grooves that are 0.206 inches wide and center-to-center distance between grooves is 0.394 inches. The grooves on Picatinny rails are evenly spaced and run almost the entire length of the rail. The rail is undercut to form a “flattened T” with a hexagonal top cross-section. The bottom of the grooves on the Picatinny rail are square.

Conforming to the dimensions compatible with Picatinny rail defined some other dimensions, constraining possibilities such as how many BBs could fit into the ammunition storage compartment or how much space was available to cut out for the locking pin/tool as examples. Not taking away too much material to ensure strength of the body while also retaining features has taken a lot of consideration and prototyping. There was also a good bit of concern placed into retaining manufacturing simplicity to fortify potential profitability.

Regarding elastic securing, some slingshots require you to tie the elastics onto the forks, force tubing over a rod, use clamping apparatus which require a tool rarely incorporated into the slingshot, or a tension plug such as disclosed in US9726451 (I tried this style of attachment, not this specific model and found the bands slipped). Tubing plugs such as those described in U.S. Pat. Nos. 4,307,699 and 3,494,346 are not compatible with elastic bands.

It would be desirable to provide an improvement to the ergonomics, portability and band attachment methods associated with slingshots, while also providing other functionality generally not associated with slingshots.

### SUMMARY OF THE INVENTION

One aspect of the invention resides in a multi-purpose, modular, ergonomic grip having multiple uses: slingshot, firearm fore grip, camera mount, glass breaker/force multiplier, bicycle handle etc. This low-profile design, lacking the typical Y geometry of a conventional slingshot fits into a pocket or bag far more sleekly than other available options. Some conventional slingshots have ammunition storage. However, the removable ammo storage compartment on this design offers other potential uses for the compartment space in the body via accessory inserts: whistle, flashlight/laser switch, electronic airsoft/paintball trigger, etc. Also, a simple plug demonstrates the ability to customize pistol grip (finger hole side) geometry via inserts retained using similar registration points as plug demonstrates.

An integrated hex wrench (used for accessory clamps) stows in the body locking in the ammunition storage compartment and can function as a thumb rest when partially removed from body. Integrated sighting devices are incorporated in grip body. Most elastic clamps also have built-in sights. The Picatinny screw slot transversing the exterior of forks can be used as aiming assistance when elastics are affixed in either the center of the forks using plug/plate mechanism or top of forks using an accessory clamp.

A Picatinny compatible rail design extends from the outer periphery of the slingshot forks. This rail system facilitates clamping of elastic elements while also allowing for easy and nearly infinite customization of grip body using both proprietary and off-the-shelf Picatinny conforming hardware: longer/wider forks, arrow rest, fishing reel etc. Adherence to dimensions compatible with the Picatinny rail standard allows the grip to easily be attached to most any device also possessing a Picatinny rail via Picatinny-Picatinny couplers of appropriate dimension. Clamps are designed to capture the slingshot rail and secure elastic tubing or bands in a range of thicknesses to forks.

The grip body of the invention may possess an inner color stripe which aids user in setting proper wrist azimuth. Slots centrally located in forks allow elastic elements to pass through them, arresting motion perpendicular to direction of projectile/elastic travel, thereby reducing the propensity for elastics to wrap over slingshot forks when fired.

The slingshot in accordance with the invention can be fired in multiple grip configurations, i.e., standard (finger hole on top, +/−thumb rest), Peruvian (finger hole on bottom), a pistol. Elastics can be attached to grip in any of several ways: outside of forks, top of forks, inside (center) of forks.

Another aspect is to render the slingshot suitable for use of elastic tubings or bands with all attachment methods and grip modes.

### BRIEF DESCRIPTION OF THE DRAWINGS

For a better understanding of the present invention, reference is made to the following description and accompanying drawings, while the scope of the invention is set forth in the appended claims.

FIG. 1 shows a front view of a slingshot with elastic elements wrapped around body to conserve space when the slingshot is not is use in accordance with the invention.

FIG. 2 shows a rear view thereof of the slingshot of FIG. 1.

FIG. 3A shows the body of the slingshot of the invention being held approximately plumb where the aiming stripe appears least visible on all surfaces.

FIG. 3B shows the body of the slingshot of FIG. 3A being held after adjusting the wrist forward. The aiming stripe appears thicker on the bottom (ground facing) surfaces with the stripe being thinner or invisible on the top (sky facing) surfaces (depending on severity of wrist tilt). The method of operation is the same with the wrist angled back (not pictured) however the visible/non-visible surfaces previously describe are reversed.

FIG. 4A shows a side isometric view of the slingshot of FIGS. 1 and 2 but in a standard, loaded pre-deployed position with the elastic element of the slingshot ready to be stretched by a person so as to position a projectile to move in a desired direction upon release of the elastic band by the person.

FIG. 4B shows a front isometric view thereof.

FIGS. 5A, 5B, 5C show side isometric views in progressive sequence of the release of a stretched elastic element of the slingshot by a person and showing how the projectile moves in the desired direction in response to forces that acted upon it from the release of the stretched elastic element and how the elastic element moves from the release. The projectile is a sphere.

FIGS. 6A and 6B are side views of a conventional, non-fletched dart and a conventional, fletched dart, respectively.

FIG. 7A shows a side isometric view of the slingshot of FIGS. 1 and 2 with its body held in a pistol grip deployed position by a person with the ammunition loaded and elastic element ready to be stretched so as to move the elongated projectile of FIG. 6 in a desired direction upon release of projectile by the person.

FIG. 7B shows the opposite side isometric view thereof.

FIGS. 8A, 8B, 8C show front, rear and side views of that body of the slingshot in accordance with the invention being held in a Peruvian grip position with the finger hole low and thumb rest undeployed.

FIGS. 9A, 9B, 9C show front, rear and side views of that body of the slingshot in accordance with the invention being held in a standard grip position with the finger hole high and thumb rest undeployed.

FIGS. 10A, 10B, 10C show front, rear and side views of that body of the slingshot in accordance with the invention being held in a standard grip position with the finger hole high and thumb rest deployed.

FIG. 11 shows a side view the body of the slingshot in accordance with the invention of FIGS. 1 and 2 with its elastic element, strap and clamps and showing the body attached to an underside of a long-barreled firearm using a Picatinny-Picatinny adapter to serve as a handhold grip for the user of the gun.

FIG. 12 shows a side view as in FIG. 11 but without the elastic element, strap or clamps.

FIG. 13 is an isometric side view of the body of FIG. 12 being gripped as a handhold by a user of the gun.

FIG. 14 shows the front of the body of the slingshot in accordance with the invention being held in the palm of a hand with the finger hole to the right.

FIG. 15 shows the rear of the body of the slingshot of FIG. 14 being held in the palm of the hand with the finger hole to the left instead.

FIG. 16 shows an exploded view of the components of the body of the slingshot in accordance with the invention prior to assembly.

FIGS. 17-18 show different exploded views of ammo storage aligned with its cavity in the slingshot body.

FIG. 19 shows an exploded view of the retention insert for the ammo storage of FIGS. 17-18 in alignment with where it is to be inserted into the slingshot body to retain the ammo storage in place.

FIG. 20 shows an exploded view of the clamp aligned with where it is to be clamped onto the slingshot body.

FIG. 21 shows an exploded view of the inner elastic plate on the slingshot body with the plug aligned with its opening to secure the plate in position on the slingshot body.

FIGS. 22A, 22B, 22C, 22D are progressive views of FIG. 21 in cross-section showing operation of the elastic element capturing plate/plug device securing elastic elements (tubing demonstrated) to a slot in a fork in accordance with the invention.

FIG. 23 is an isometric view of the slingshot in accordance with the invention without an elastic element.

FIG. 24 is an end view of a clamp in a fully closed position.

FIG. 25 is an isometric view of a clamp's components and complementary rail geometry.

FIG. 26 is an isometric view of the clamps prior to their securement to the body of the slingshot.

FIGS. 27-30 are isometric views showing how a clamp in accordance with the invention is positioned to be secured to slingshot body.

FIG. 31-33 are isometric views that demonstrate alternate perspective views of components of the body that are related particularly to rail geometry.

FIGS. 34-38 are isometric views showing the clamp of FIGS. 27-33 in various secured positions. Clamp integrated sighting devices are depicted.

FIG. 39 is a cross-sectional view of the slingshot assembly in accordance with the invention that includes, among other components, a clamp deployed, a Picatinny like screw slot that prevents lateral movement of clamps, vacant tapped and untapped holes.

FIG. 40 is a cross-sectional view of the slingshot assembly in accordance with the invention that shows, among other component, a plug, plate and grub screw in position.

FIG. 41 is a progressive view of the slingshot in accordance with the invention for securement of an elastic element by a clamp. The elastic passes through fork aperture in this configuration.

FIG. 42 is a progressive view of the slingshot in accordance with the invention for securement of an elastic element by a clamp. The elastic element does not pass through fork aperture in this configuration.

FIG. 43 is a progressive view of the slingshot in accordance with the invention for securement of an elastic element by a clamp for a pistol grip.

FIGS. 44 and 45 are isometric side and rear views showing a manner of attaching a fishing reel to the slingshot of the invention.

### DETAILED DESCRIPTION OF THE INVENTION

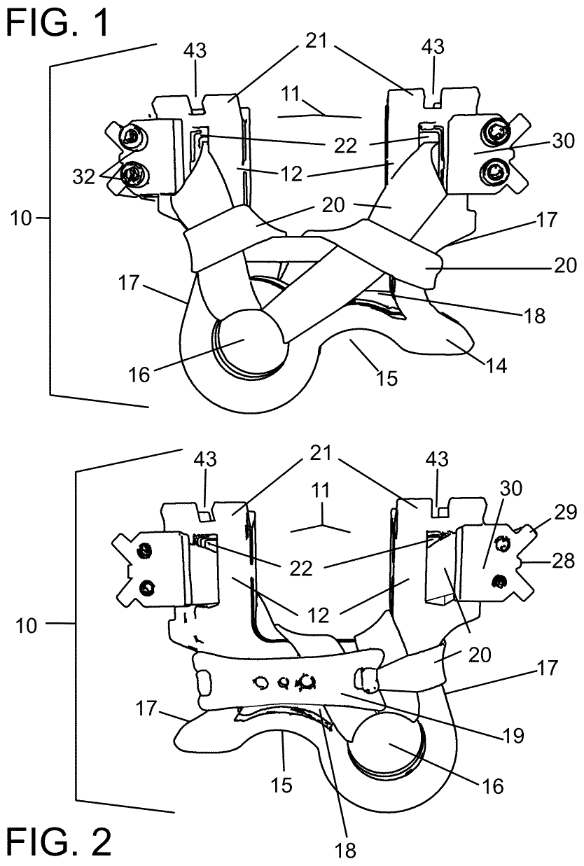

Turning to FIGS. 1 and 2, a handleless slingshot is shown in accordance with my invention that is multi-purpose, modular, compact, multi-functional and ergonomic. The handleless slingshot lacks the conventional handle of a Y geometry, and thus fits into a pocket or bag far more sleekly than would otherwise be the case and in that sense is more easily stowed in the pocket or bag. The grip geometry of the handleless slingshot in accordance with the invention facilitates band confinement when not in use.

The slingshot includes a body 10 with two forks 12 and a base 14. The forks 12 are symmetric and extend parallel to each other from the base 14. Each fork 12 has a Picatinny compatible rail 21 extending from outward facing extremities of forks. The base 14 has a finger hole 16, a cavity 18 and a periphery.

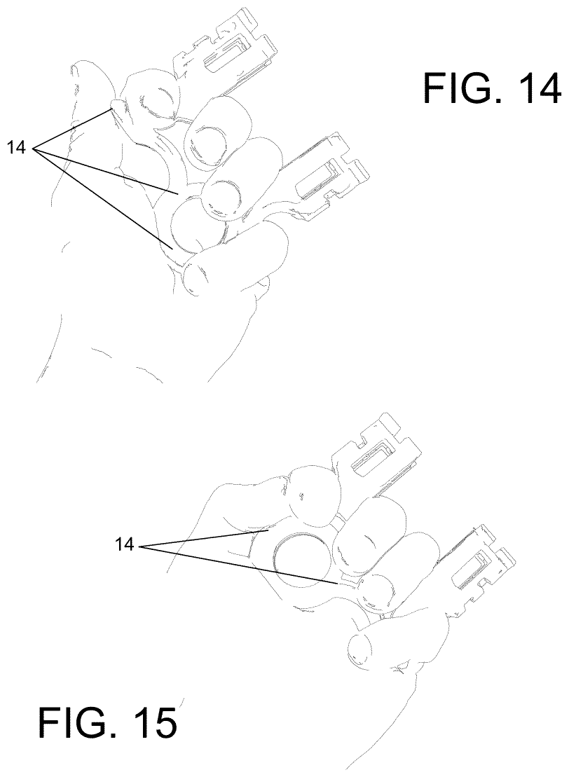

The periphery has two concavely curved surfaces 17, which face outward away from each other on opposite sides of the base 14, and another concavely curved portion 15, which is arranged further from one of the two forks 12 than from the other of the two forks and is closer to the finger hole 16 than to a gap 11, which separates the forks 12 from each other. The finger hole 16 is closer to one of the two forks 12 than to the other of the two forks 12. Two of the three concave surfaces 17 face outward away from each other on opposite sides of the base 14. As a result, the body 10 is compact for being carried in a pocket or bag. Indeed, as seen in FIGS. 14 and 15, the slingshot base 14 is sized to fit in the palm of an adult hand.

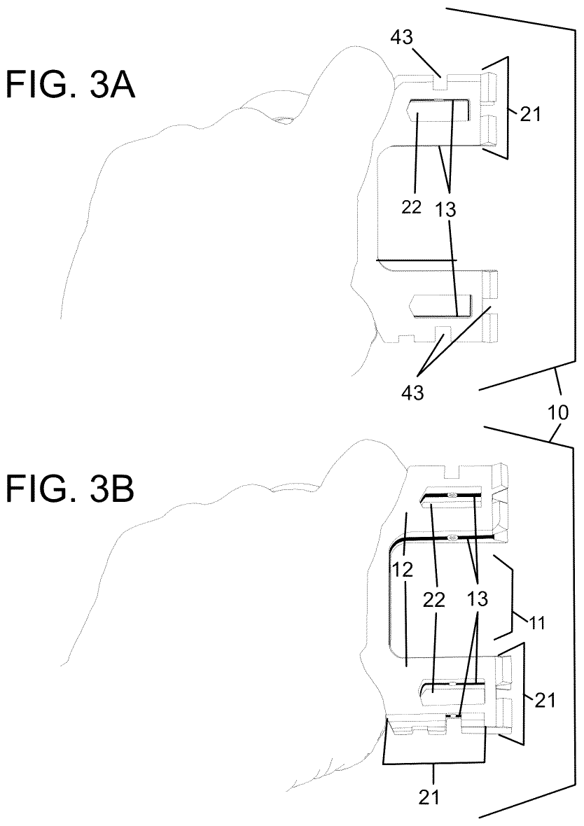

FIGS. 3A and 3B show an aiming stripe 13 that can assist the user for aiming the slingshot so that the projectile 40 that is released by exerting force upon it from bands or tubing that were under tension when stretched will more likely strike its intended target. The user tilts their wrist forward or backwards as needed, the visible width of stripe 13 changing in accordance with angle of body 10 thereby allowing user to more accurately control trajectory of projectile 40. Each of the two forks 12 has a respective aperture or slot 22 with an inner surface having the color stripe 13 to aid in realizing proper wrist azimuth for the user. When body 10 is held at approximately eye level, the width of stripe 13 visible is nominal on all surfaces as show in FIG. 3A. As grip body 10 is angled forward, the width of visible aiming stripe 13 increases on bottom (ground facing) surfaces of body while becoming invisible on top (sky facing) surfaces as shown in FIG. 3B. The method of operation is identical for angling body 10 backwards; however, visible and invisible surfaces are reversed.

The forks 12 are part of a custom fork rail 21 system, conforming to the Picatinny standard, that allows for compatibility with an array of elastic elements 20 (tubings and bands) by using accessory clamps 30 while also doubling as a removable, accessorial grip for cameras, guns, glass breaker/striking device, bicycle grip, fishing reel handle/bait launching device, launching of arrows or bolts using accessory attachments such as an arrow rest, launching of weights for climbing ropes (arborists), antenna installation etc. The clamps 30 may be tightened with hex screws 32. The integrated rails 21 are compatible with most standard Picatinny clamps and accessories.

For purposes of storage, the elastic element 20 (such as an elastic band or an elastic tubing with free ends) may be wrapped around the body in the manner shown in FIGS. 1 and 2 and the free ends held to each other by a strap 19. The custom fork rail system includes two parallel portions (forks) 12 with rail 21 extending from outward facing edges of fork 12.

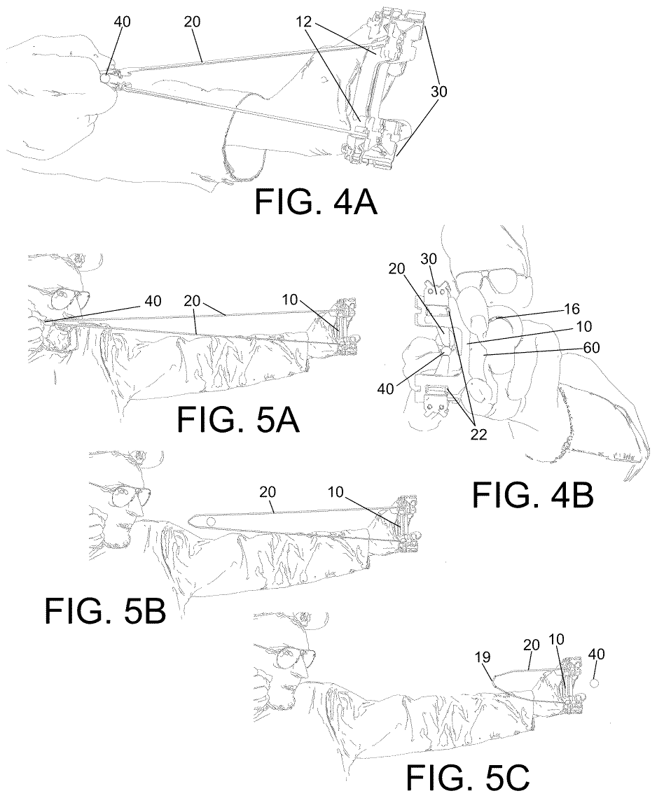

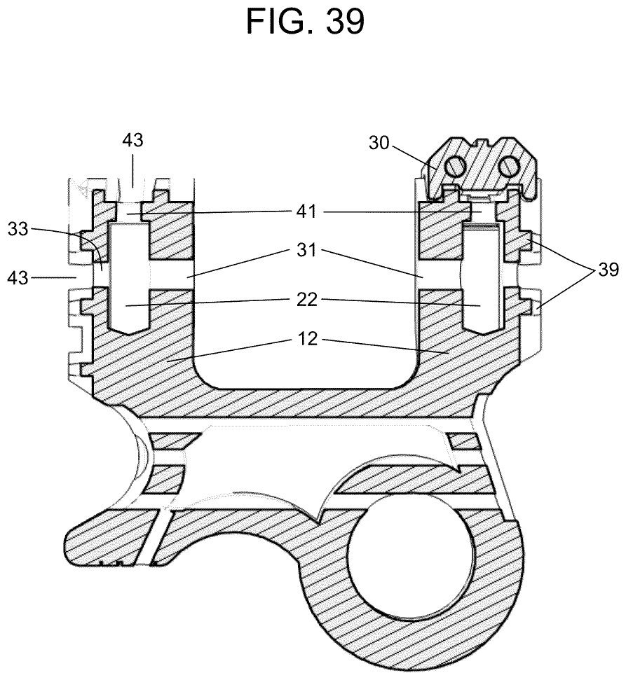

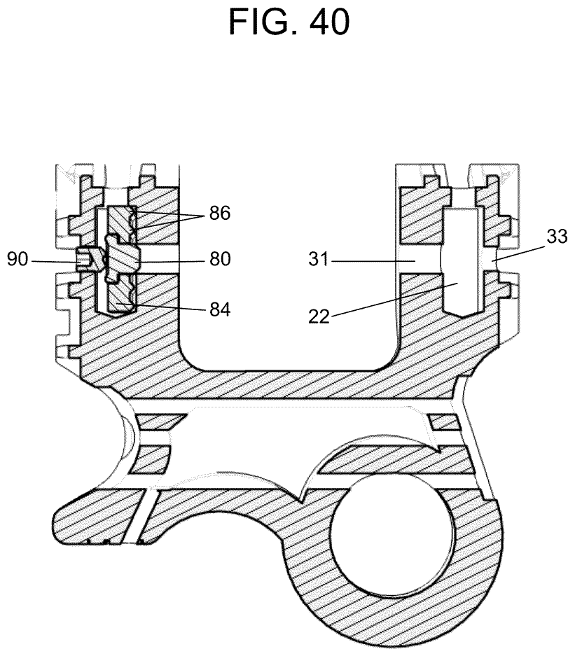

FIGS. 4A, 4B, 5A, 5B and 5C show how the slingshot may be gripped for readying and firing a projectile 40 in the form of a spherical shot, pellet or BB. There are means provided for retaining the elastic element 20 to each of the two parallel portions 12. For instance, a Picatinny rail compatible clamp 30 may be used as shown in FIGS. 24-39, 41-43.

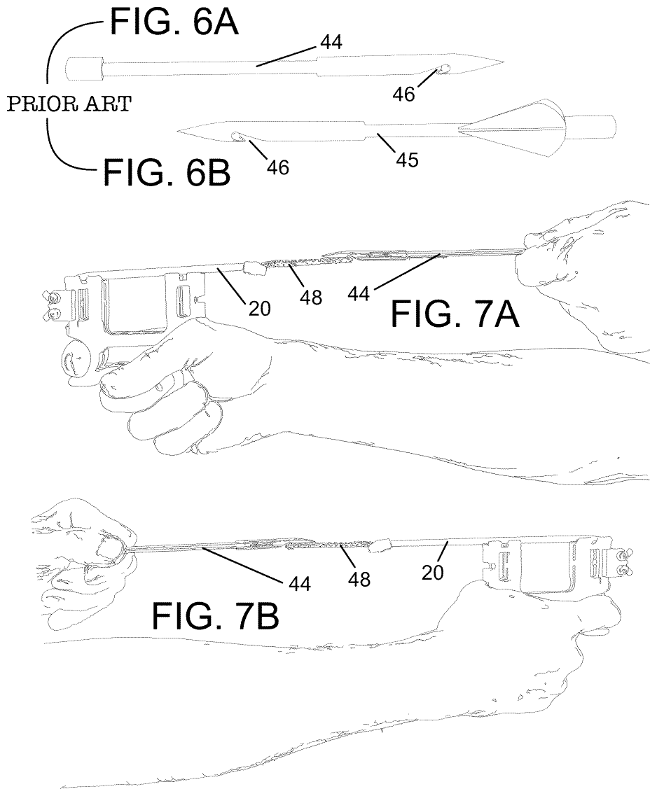

With respect to FIGS. 6A, 6B, 7A, 7B, the link between the elastic element 20 and the non-fletched dart 44 or (fletched dart 45) is a simple loop of cord 48 (could be wire) to mediate connection between the thick elastic element 20 and the much smaller notch mouth 46 of the non-fletched dart 44 (or fletched dart 45). Both pistol grip and conventional grips are suitable for launching of fishing lures with an appropriate mediation device such as cord 48.

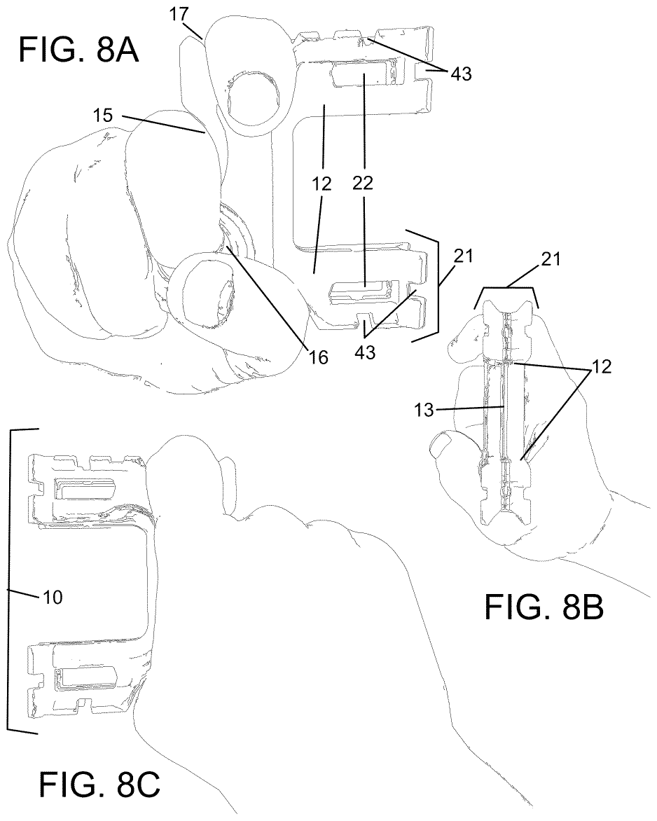

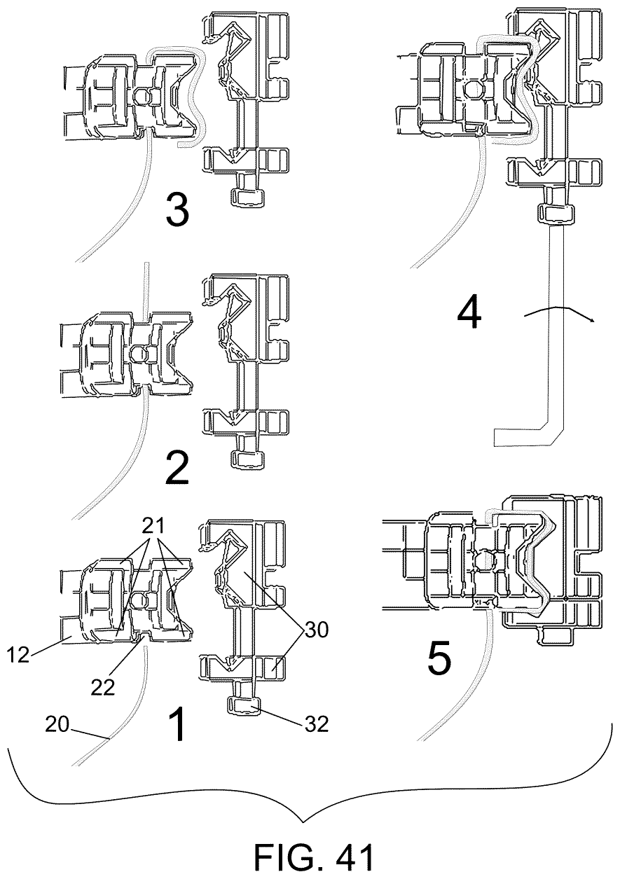

Turning to FIG. 8A, respective apertures or slots 22 in the center of the forks 12 provide an optional shooting mode where elastic element 20 passes through the respective aperture or slot 22. This configuration arrests movement of elastic element 20 perpendicular to its plane of launching motion of a projectile such as a conventional BB or spherical shot or spherical pellet 40 (see FIGS. 3-5C), thereby greatly reducing the propensity for elastic element 20 to wrap over the forks 12, while simultaneously reducing strain on the clamping mechanism 30 (see FIG. 41). The elastic element 20 may be a cut elastic band so as to have two free ends or may be an elastic tubing. Unless using a single tube (only compatible with the pistol mode), both bands and tubing have two free ends which are clamped and two ends joined by either a strap/pouch 19 or heavy-duty wrap simulating a bow string.

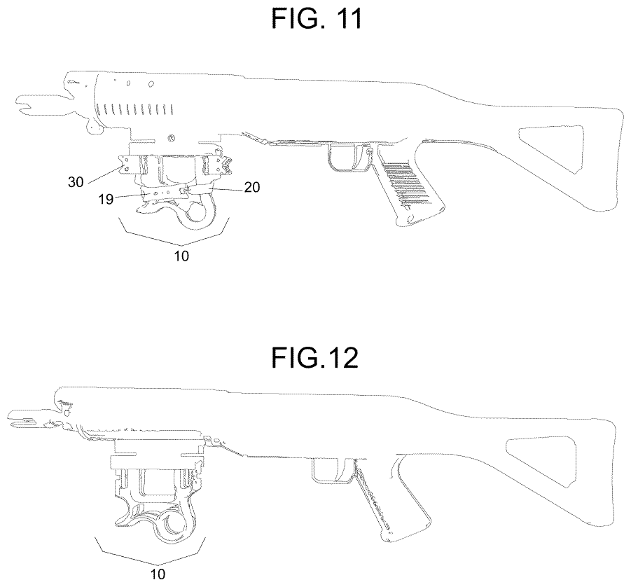

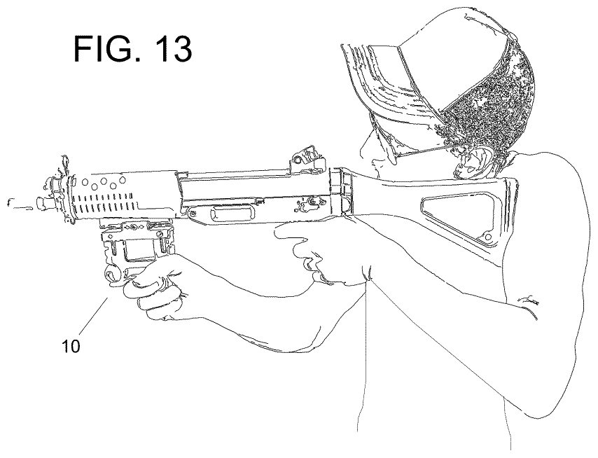

Turning to FIGS. 11-13, the body 10 may be secured to the underside of a firearm to be grasped by the user during firing of the firearm. The two forks 12 extend as two parallel portions each having a respective central slot 22 and peripheral mounting rail 21 compatible with existing standards which extend from the respective parallel portion's outward periphery. The slingshot body 10 can be retained to other bodies such as firearms using coupling clamps conforming to same rail standard. As FIGS. 14 and 15 show, the base 14 of the body 10 can fit into the palm of an adult hand when held.

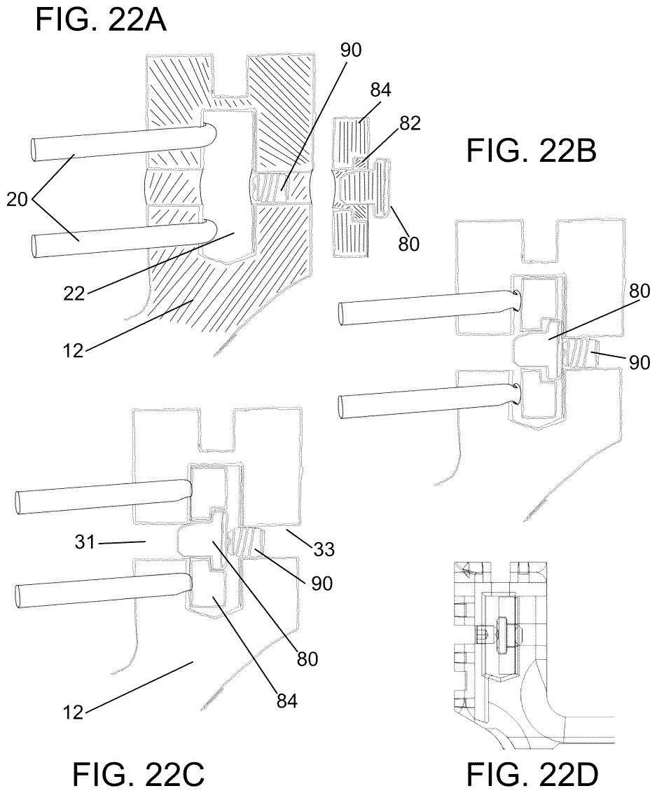

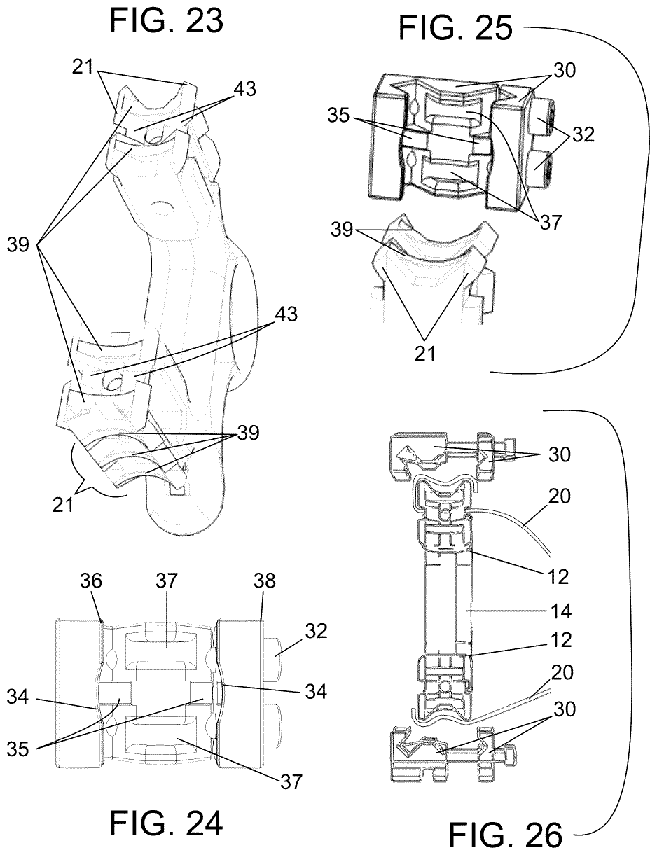

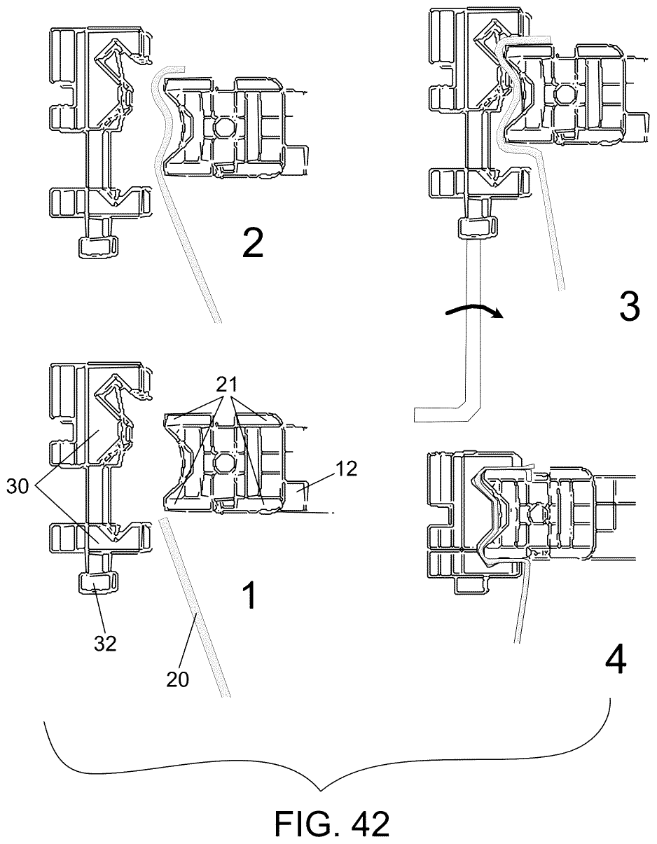

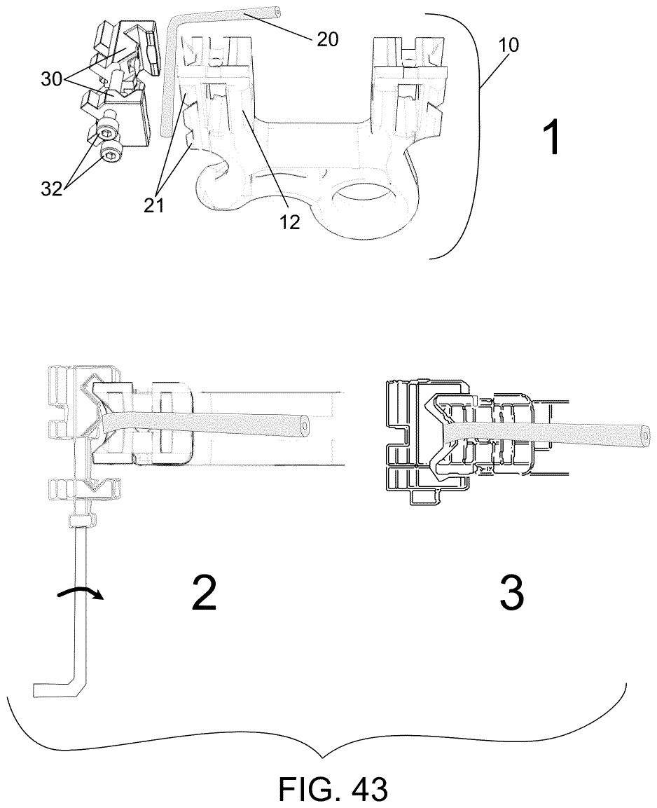

The elastic element 20 can be attached to:
Exterior top and sides of forks 12 with elastic element 20 passing through the respective apertures 22 and clamped to the rails 21 using clamp 30 (see FIG. 41). Exterior top and side of forks 12, elastic element 20 clamped to rail 21 with clamp 30 (see FIG. 42).
Inside fork 12 aperture 22 with plate 84/plug 80 (see FIGS. 22A-22D)
Collinear with body. Outside of fork 12, elastic element 20 clamped to rail 21 with clamp 30 (see FIG. 43).

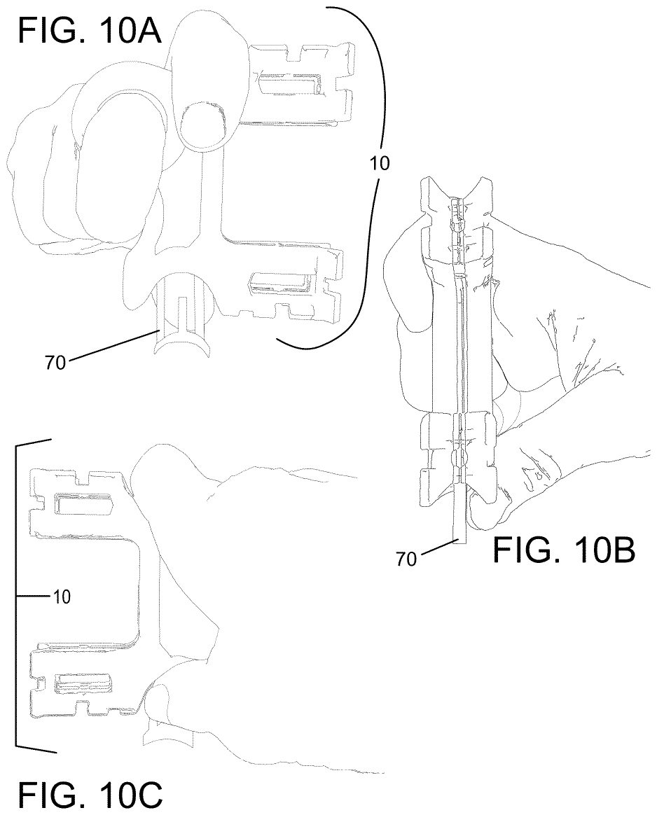

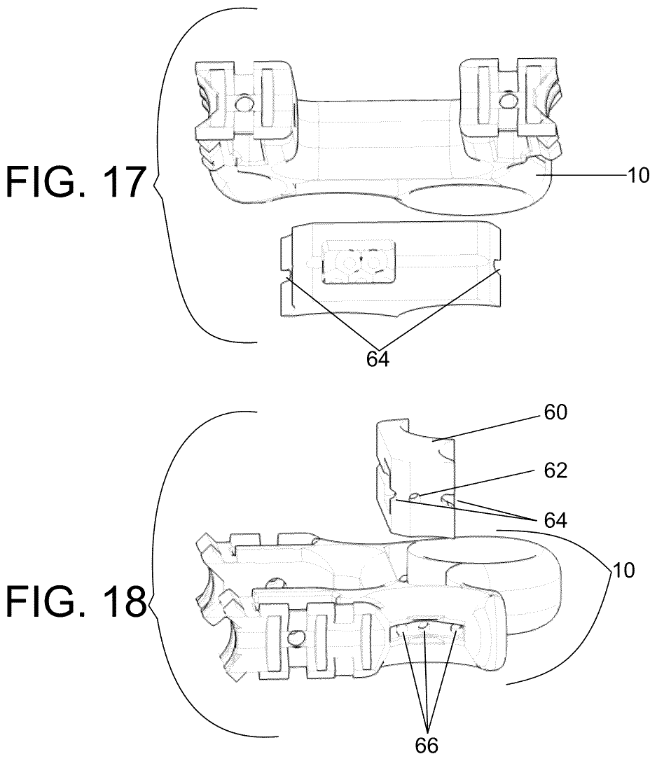

Turning to FIGS. 1, 16-18, the cavity 18 in the body 10 in accordance with the invention offers other potential uses besides that for accommodating an ammo storage compartment 60, namely, a whistle, a flashlight/laser switch, an electronic airsoft/ paintball trigger, etc. An integrated hex wrench 70 (used for accessory clamps) can also function as a thumb rest when partially removed from body 10 (see FIGS. 10A-C).

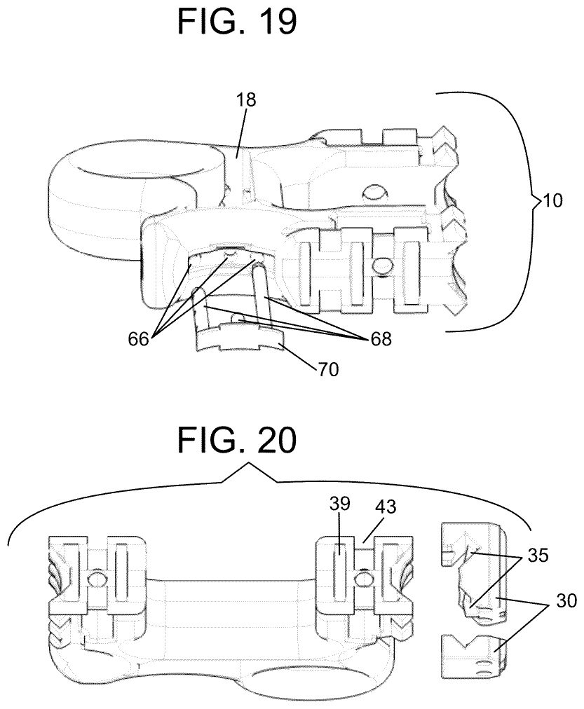

Turning to FIGS. 18-19, the ammo storage compartment 60 is secured within the chamber 18 by the hex wrench/locking pin element 70. The ammo storage compartment 60 may have three through-going channels or some variation that employs some recesses instead of channels. For instance, a through-going channel 62 and two peripheral recesses 64 that are in alignment with an associated three through-going channels 66 in the base 14 of the body 10.

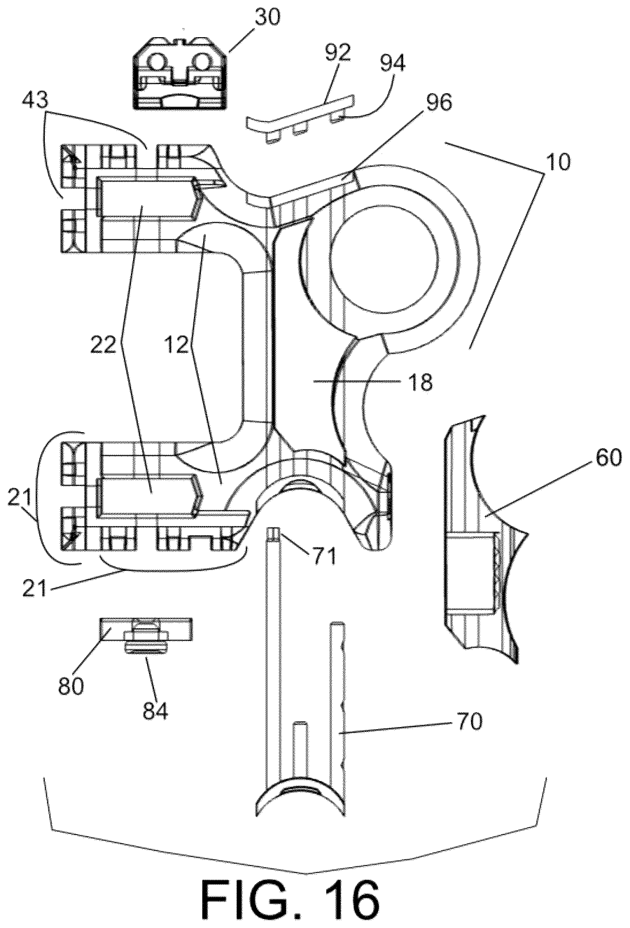

The locking pin element 70 has prongs 68 including one positioned to enter the middle of the three channels 66 and two positioned to enter an associated two end ones of the three channels, which in turn are aligned with the through-going channel 62 and the respective peripheral recesses 64 of the ammo storage compartment 60 when the ammo storage compartment 60 is in place in the chamber 18 in the base 14 of the body 10. As shown in FIG. 16, a cover 92 (or grip modifying insert with similar projections as 94) may be fitted into a recess 96 in the body 10 and has projections 94 that may be fitted into corresponding openings in the recess to close same in alignment with the prongs 68 of the locking pin element 70.

Turning to FIG. 16, a Picatinny style screw slot 43 transverses the rail 21 on the extremity of the forks 12 and can be used for aiming assistance when elastics 20 are affixed in slots 22 (FIGS. 22A-22D) or affixed to rails 21 on top of forks 12 with clamp 30. The rails 21 are preferably Picatinny compatible rails that have slots or grooves each defined by a pair of parallel surfaces and by a recessed surface that extends perpendicular to the two parallel surfaces. Each of the forks 12 has two side surfaces and an end surface. The end surface extends between the two side surfaces. A Picatinny rail configuration is on the periphery of each of the end surfaces of the forks and of one of the side surfaces of the forks that face away from each other.

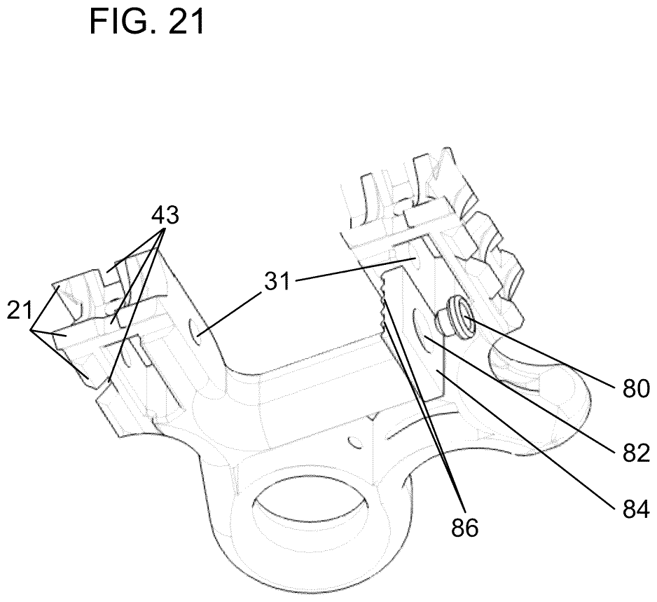

Turning to FIG. 21 and FIGS. 22A-22D, the clamp operation is shown with elastic tubing and a fork plate/plug. The fork plate 84 has teeth 86 and preferably has a square configuration so that it can be used with the teeth in either a vertical or horizontal orientation. Horizontal teeth seem to work better for elastic bands while vertically oriented teeth seem better for tubing.

FIG. 22A shows one of the forks 12 with tubings 20 positioned inside of the slot 22 prior to insertion of the fork plate 84/plug 80. The fork plate/plug assembly includes a plug 80 having a stem and having a larger diameter head and includes the fork plate 84 with a recessed opening 82 that accommodates insertion of the plug 80 in a manner that allows the end of the stem of the plug 80 to protrude beyond the confines of the fork plate 84 and allows the head of the plug to press against the recessed portion 82 of the fork plate 84.

FIGS. 22B-22D show the securement operation of the fork plate 84/plug 80 with tubing 20 in cross section but section lines are omitted to better emphasize the components like the grub screw 90. The only difference between how the fork plate 84/ plug 80 combo functions with an elastic band vs tubing is that the band is slightly pushed into cavity 31 on the inside of the fork 12 by the tip of the plug 80 when compressed. A grub screw 90 is within a tapped cavity 33, which extends from an exterior of a respective fork 12 to the respective aperture or slot 22. By turning the grub screw 90 in a direction that exerts a force on the plug 80 (e.g. clockwise), an end of a stem of the plug eventually enters another cavity 31 in alignment with the cavity 33 on the opposite side of the fork 12 while the head of the plug 80, which is a greater diameter than the stem, presses the fork plate 84 against portions of the tubings 20 inside the respective aperture slot 22.

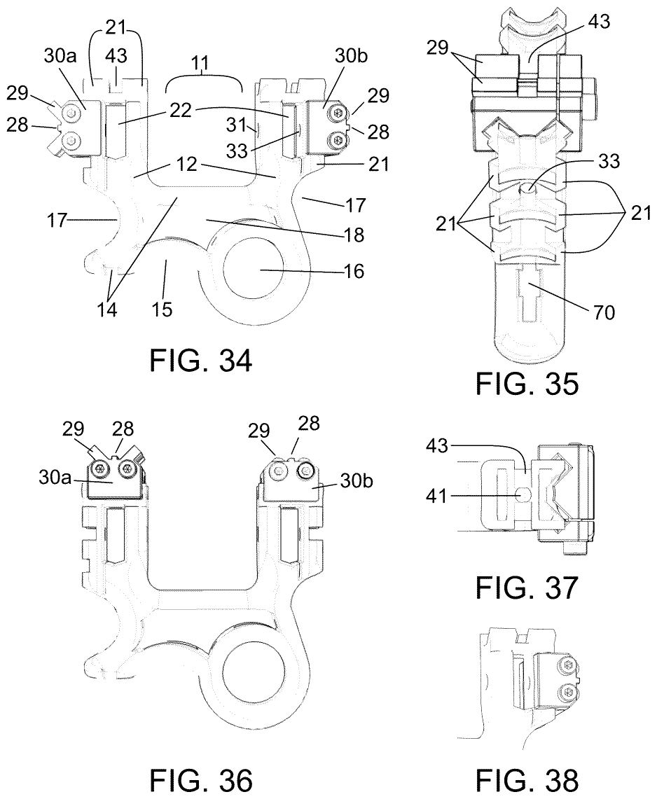

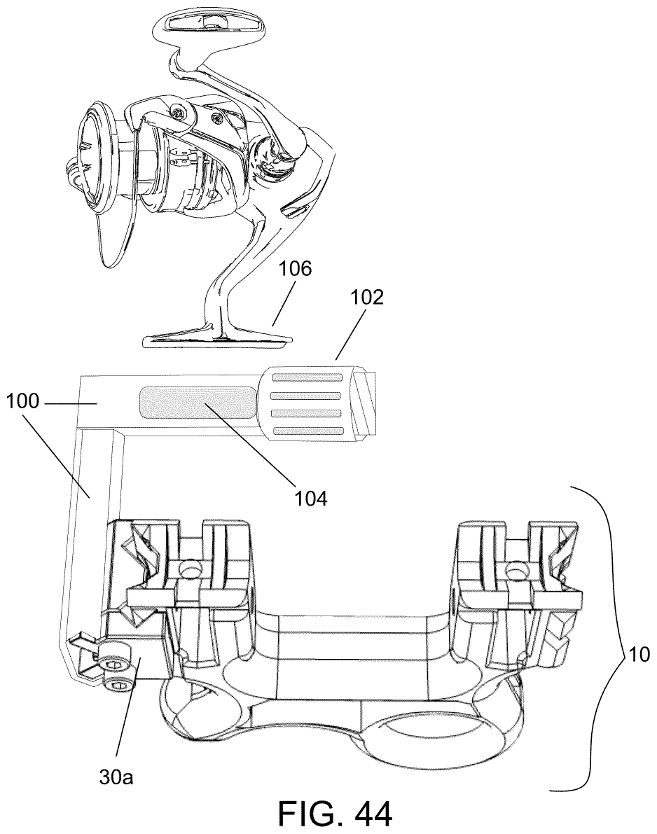

Turning to FIGS. 34-38, I have two versions of clamp 30: a version 30a having a Picatinny compatible mounting rail extending from the outermost surface of clamp 30a and low-profile version 30b. The combination of components post 28 and notch 29 form the integrated sighting devices. Clamp 30a utilizes a notch 29 having Picatinny rail compatible dimensions projecting from the clamp's outermost surface (orientation offset 90-degrees from the rail 21 clamp 30a mounts on). The manner of operation in regards to the elastic attachment and coupling to rail 21 is otherwise the same for both versions of clamp. The 90 degrees offset rail/notch 29 on the larger clamp 30a is the intended attachment point for a fishing reel adapter 100 (see FIG. 44); however, a user can just as easily attach Picatinny compatible adapters to any of the other rails on the body as well.

The manner for attaching bands to the top of the slingshot body is the same as for the sides with the caveat that only tubing or narrow bands can run through the forks in this configuration due to the width of slot 22 in the middle of fork 12. FIGS. 35-36, 39 demonstrate clamps 30 attached to the rails 21 on top of forks 12.

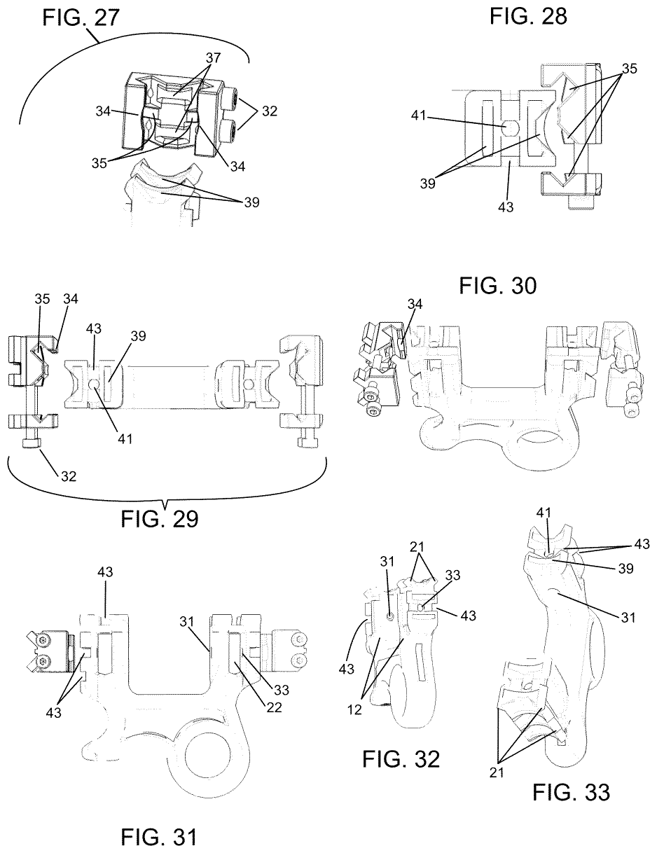

Turning to FIGS. 27-38, registration teeth 35 are positioned in correspondence with the slot 43 to arrest longitudinal movement of clamps 30. Teeth 35 simulate the screw in a traditional Picatinny clamp. There is a concavely curved recess 34 to prevent elastic tubing 20 from rolling out from under the clamp 30 when the tubing is not fully captured in the slot 43. Depending on diameter of tubing used, you can capture one or two tubes in the slot 43 with any additional tubing running over the rails 21 in the same manner as elastic bands. Tubing that was not captured in the slot 43 had the potential to roll out from under the clamp, but the concavely curved recess 34 prevents this.

A registration recess 37 of clamp 30 mates in correspondence with a tooth ridge 39 of the rail 21 and captures elastic element 20 running either collinear or perpendicular. There are hex screws 32. Slots 43 are in correspondence with teeth 35 that conform to the Picatinny rail standard in the horizontal plane. A tapped hole 41 is provided for accessory equipment. A pass-through hole 31 is provided for accessory equipment, (also 80, 84 related). A tapped aperture 33 running from fork 12 extremity to slot 22 for grub 90 or accessory equipment is provided. Post 28 and notch 29 form the integrated aiming feature on clamp 30.

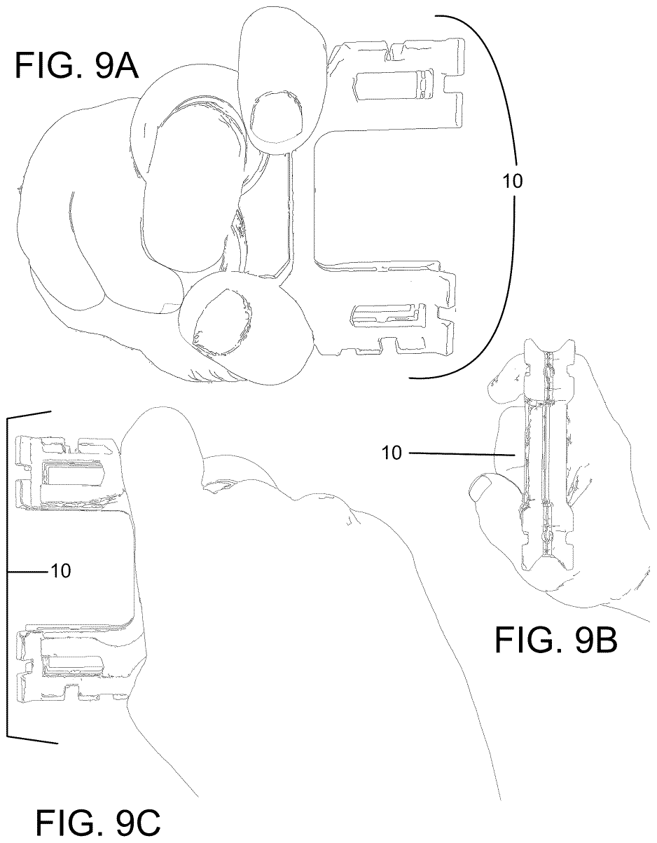

The slingshot can be fired in multiple grip configurations:
Standard (finger hole on top) with thumb rest deployed (FIGS. 10A-10C)
Standard (finger hole on top, thumb rest not deployed) (FIGS. 9A-9C)
Peruvian (finger hole on bottom. thumb rest not deployed) (FIGS. 8A-8C)
Pistol (FIGS. 7A-7B)

An elastic element 20 can be attached to fork 12 several ways:
Fork 12 side rails 21 (FIGS. 41-43)
Fork 12 top rails 21 (not pictured, same method as side attachment)
Inside (center) of forks 12 aperture 22 (FIGS. 22A-22D)

In developing the present invention, my hope was to make something that could easily be used with a variety of elastic elements without needing sized adapters or similar equipment. The attachment methods I have come up with have achieved this goal and work for both tubing and bands in the normal range of thicknesses used in slingshots.

Turning to FIGS. 39 and 40, a Picatinny screw slot 43 prevents lateral movement of clamps 30. There is a tapped hole 33 for receiving the grub screw 90 (which when turned moves plug 80) or other accessory screw, for example, glass breaker points. A similar tapped hole 41 is provided on the perpendicular plane to hole 33 for accessory attachments. An untapped, pass through channel 31 serves as a registration hole/capture point for the plug 80 being urged or moved by the turning of the grub screw 90 (see FIGS. 22C, 22D). The alignment of hole 33 and channel 31 allows for the threading of a through-rod for accessories, for example, an arrow rest.

FIGS. 41-43 show the manner of securing a clamp 30 in respective positions for retaining the elastic band or tubing to the fork 12 rails 21 of the slingshot in accordance with a desired elastic path for the elastic element 20. The respective positions represent a respective elastic path through the apertures 22 (FIG. 41), outside the forks 12 (FIG. 42) and collinear with body 10 (FIG. 43).

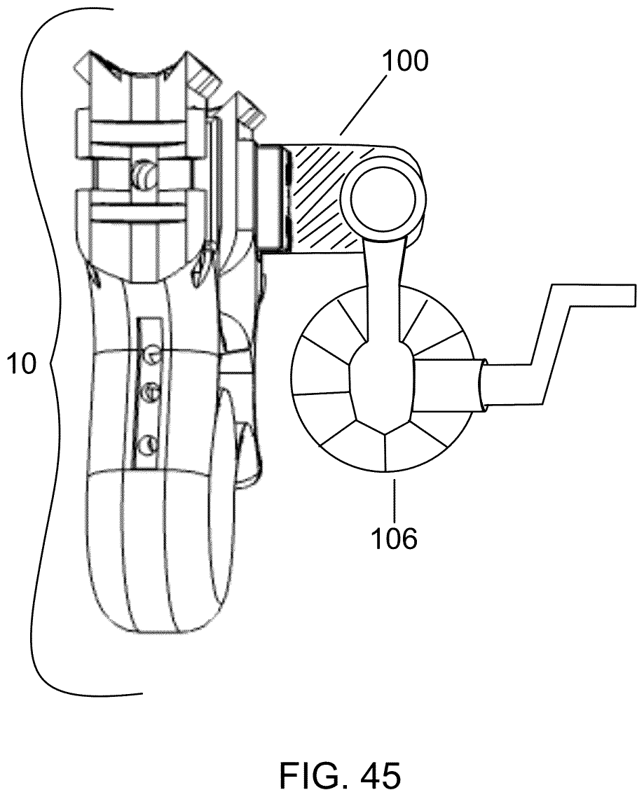

Turning to FIGS. 44 and 45, there is a fishing reel adapter body 100, a threaded retention collar 102 captures a reel foot 106 in slot 104 as is standard on most fishing rods. The slot 104 is mirrored on top and bottom of the fishing reel adapter body 100 to allow for multiple mounting configurations. Clamp 30a having aiming notch 29 compatible with Picatinny standards can act as the attachment point for adapter body 100.

While the foregoing description and drawings represent the preferred embodiments of the present invention, it will be understood that various changes and modifications may be made without departing from the scope of the present invention.

What is claimed is:

1. A slingshot, comprising:
a body having a base and two forks extending from the base and separated from each other by a gap, the base having a finger hole and having a periphery with three segments that are concavely curved, the finger hole being closer to one of the two forks than to another of the two forks, two of the three segments that are concavely curved facing outward away from each other on opposite sides of the body, a remaining one of the three segments that is concavely curved being further away from the one of the two forks than to the other of the two forks and being closer to the finger hole than to the gap.

2. The slingshot of claim 1, further comprising:
an elastic element; and
means for retaining the elastic element to the body.

3. The slingshot of claim 1, wherein the base includes an open compartment having a configuration, further comprising
an ammunition storage unit having a configuration that complements the configuration of the open compartment; and
retaining means for keeping the ammunition storage unit inside the open compartment.

4. The slingshot of claim 3, wherein the keeping means includes prongs extending through the base and the ammunition storage unit via channels and/or recesses in alignment with each other respectively in each.

5. The slingshot of claim 2, wherein the retaining means for retaining the elastic element to the body includes clamps each secured to respective ones of the parallel portions and that are operative between clamped and unclamped orientations for respectively securing and releasing the ends of the elastic element.

6. The slingshot of claim 1, wherein the two forks each have a respective slot, wherein the means for retaining the elastic element to the body including means for retaining portions of the elastic element in position within the respective slots.

7. The slingshot of claim 6, wherein each of the forks have aligned cavities in communication with the respective slot, the retaining means for retaining portions of the elastic element within the respective slots including plates fitted inside the respective slots, each of the plates having a hole in which is arranged a fastener having a stem and a head wider than the stem, the head being arranged to press the plate against the portions of the elastic element, the stem having an end arranged to enter one of the aligned cavities from a force exerted by a screw in another of the aligned cavities.

8. The slingshot of claim 3, wherein the ammunition storage unit contains a plurality of spherical shots or pellets or BBs.

9. The slingshot of claim 2, further comprising
a dart having a recessed hook; and
a cord grasped by the hook and connected to the elastic element.

10. The slingshot of claim 2, further comprising:
a spherical shot or pellet or BB against a central region of the elastic element, which in turn is under tension.

11. The slingshot of claim 2, wherein the elastic element is selected from the group consisting of elastic bands and elastic tubings.

12. The slingshot of claim 2, wherein the means for retaining the elastic element to the body includes means for retaining the elastic element to the forks of the body with a clamp, the clamp and the forks having complementary surfaces that complement each other when positioned adjacent to each other, one of the complementary surfaces having a convex curvature and another of the complementary surfaces having a concave curvature.

13. The slingshot of claim 12, wherein the clamp is configured to clamp the elastic element against one of the forks in any of three different orientations, the different orientations including a through the fork path for which the elastic elements extend through applicable slots in the forks and continues along curvature between complimentary surfaces, an outside the forks attachment method where the elastic elements extend along curvature between the complementary surfaces, and a pistol grip position for which the elastic band extends between the complementary surfaces but in a direction that is transverse to a direction of curvature across the complementary surfaces.

14. The slingshot of claim 1, further comprising;
an adapter that secures a fishing reel to the body at a location suited for grasping the body as the fishing reel unwinds a fishing line during casting or retraction of the fishing line.

15. The slingshot of claim 1, further comprising:
an attachment that secures an underside of a firearm to the body at a location suited for grasping the body to steady the firearm during firing of the firearm.

16. The slingshot of claim 1, further comprising:
an aiming stripe centered along a periphery of surfaces of the forks that bound the gap.

17. The slingshot of claim 6, further comprising:
an aiming stripe centered and extending along a periphery of surfaces of the forks that bound the gap and further aiming stripes centered and extending on surfaces of the forks that bound the slots.

18. The slingshot of claim 1, wherein a plurality of components are configured to be secured to the body alternatively, wherein the plurality of components are selected from a group consisting of clamps, an adaptor and an attachment, wherein the clamps are configured to secure ends of an elastic element to the body, the adaptor is configured to secure a fishing reel to the body at a location suited for grasping the body as the fishing reel unwinds a fishing line during casting or retraction of the fishing line, and the attachment is configured to secure an underside of the firearm to the body at a location suited for grasping the body to steady the firearm during firing of the firearm.

19. The slingshot of claim 1, wherein the forks each have a periphery with a Picatinny rail configuration that has a slot or groove defined by two respective parallel surfaces and a respective recessed surface, which extends perpendicular to the two respective parallel surfaces.

20. The slingshot of claim 19, wherein the periphery of each of the two forks include two side surfaces and an end surface that extends between the two side surfaces, one of the two sides surfaces of each of the two forks facing away from each other that each have a respective groove having a Picatinny compatible rail configuration, the end surface of each of the two side surfaces having a further respective groove having the Picatinny compatible configuration.
